(19) United States
(12) Patent Application Publication
(10) Pub. No.: US 2023/0018135 A1
(43) Pub. Date: Jan. 19, 2023

(54) APPARATUSES, SYSTEMS, AND MATERIALS FOR STIFFNESS AND DAMPING CONTROL INCLUDING RIBBED GEOMETRY, AND ASSOCIATED METHODS

(71) Applicant: HyperDamping, Inc., Cambridge, MA (US)

(72) Inventors: Ryan Lee HARNE, Dublin, OH (US); Tyler RINGLER, Columbus, OH (US)

(21) Appl. No.: 17/945,942

(22) Filed: Sep. 15, 2022

Related U.S. Application Data
(63) Continuation of application No. PCT/US2021/022763, filed on Mar. 17, 2021.
(60) Provisional application No. 62/990,606, filed on Mar. 17, 2020.

(51) Int. Cl. F16F 7/12

(52) U.S. Cl. CPC F16F 7/122; F16F 2224/0233; F16F 2234/06; F16F 2230/0023; F16F 2230/40; F16F 2228/14; F16F 2228/066; F16F 2226/04

(57) ABSTRACT

Embodiments described herein relate generally to apparatus with ribbed structures or geometries for stiffness and damping control, and methods of producing the same. In some embodiments, an apparatus includes a ribbed structure having a set of ribs, configured to deform elastically under shock. In some embodiments, the set of ribs can have a sinusoidal wave shape. In some embodiments, the set of ribs can have a heterogeneous wave shape. In some embodiments, the set of ribs can have material properties that change along the length of the ribbed structure, such as wavelength, amplitude, wave shape, and material thickness.

### CROSS-REFERENCE TO RELATED APPLICATIONS

This application is a continuation of International Patent Application No. US2021/022763 entitled, “Apparatuses, Systems, and Materials for Stiffness and Damping Control Including Ribbed Geometry, and Associated Methods,” filed Mar. 17, 2021, which claims priority to and the benefit of U.S. Provisional Patent Application No. 62/990,606 entitled “Apparatuses, Systems, and Materials for Stiffness and Damping Control Including Ribbed Geometry, and Associated Methods,” filed Mar. 17, 2020, the disclosure of which is hereby incorporated by reference in its entirety.

### TECHNICAL FIELD

Embodiments described herein relate generally to apparatuses, systems, and materials for stiffness and damping control, and associated methods.

### BACKGROUND

Embodiments described herein relate generally to apparatus, systems, and materials with ribbed structures or geometries for stiffness and damping control, and methods of using or producing the same. When subject to loads, shocks, and vibrations, a material can deform plastically and be subject to fatigue damage. Additionally, users experiencing undamped shocks and vibrations (e.g., while driving an automobile), can experience discomfort and fatigue after prolonged exposure. Corrugated structures (e.g., as found in cardboard box walls) are a commonly used technique for damping vibrations and reducing material fatigue endured by an object (e.g., using a cardboard box). Corrugated structures can improve structural integrity when incorporated into the object they are reinforcing without adding significant mass to the object. However, corrugated structures currently available can deform or break when subject to shock or heavy sudden impact, thus preventing repeated use of the corrugated structure for shock mitigation. This can make the use of corrugated structures impractical in certain applications. It can be desirable to have a material or an apparatus that can absorb a broader range of shocks and vibrations without permanent deformation or failure.

### SUMMARY

Embodiments described herein relate generally to apparatuses, systems, and materials with ribbed structures or geometries for stiffness and damping control, and methods associated with the same. In an embodiment, an apparatus includes a ribbed structure having a set of ribs, configured to deform elastically under shock. The set of ribs defines a network of trusses and beams such that the ribbed structure is configured to deform according to a sequence of stages, each stage exhibiting different stress behavior. In some embodiments, a first layer of material can be disposed on a first side of the ribbed structure. In some embodiments, a second layer of material can be disposed on a second side of the ribbed structure. In some embodiments, the set of ribs can have a sinusoidal wave shape. In some embodiments, the set of ribs can have a heterogeneous wave shape. In other words, the set of ribs can have material properties that change along the length of the ribbed structure, such as wavelength, amplitude, wave shape, and material thickness. In some embodiments, the material properties of the set of ribs can change gradually along the length of the ribbed structure. In some embodiments, the material properties can change suddenly in discrete sections along the length of the ribbed structure. In some embodiments, the ribbed structure can have a first section with a first subset of ribs and a second section with a second subset of ribs, wherein the second subset of ribs has a set of physical properties different from the physical properties of the first subset of ribs. In some embodiments, the ribbed structure can have a third section with a third subset of ribs, wherein the third subset of ribs has a set of physical properties different from the physical properties of the first subset of ribs and/or the second subset of ribs. In some embodiments, the ribbed structure can be a first ribbed structure and the apparatus can include a second ribbed structure. In some embodiments, both the first ribbed structure and the second ribbed structure can include a plurality of peaks and troughs, wherein the peaks of the first ribbed structure are coupled to the troughs of the second ribbed structure. In some embodiments, the ribbed structure can be formed into an annular shape, e.g., with a cylindrical shape, or can be shaped into other three-dimensional geometries.

### BRIEF DESCRIPTION OF THE DRAWINGS

FIG. 1 shows a schematic illustration of an apparatus with a ribbed structure, according to an embodiment.

FIG. 2 shows an apparatus with a ribbed structure, according to an embodiment.

FIG. 3 shows an apparatus with a heterogeneous ribbed structure, according to an embodiment.

FIG. 4 shows an apparatus with a heterogeneous ribbed structure, according to an embodiment.

FIG. 5 shows an apparatus with a heterogeneous ribbed structure, according to an embodiment.

FIG. 6 shows an apparatus including layers of a ribbed structure, according to an embodiment.

FIGS. 7A-7C show an apparatus with a ribbed structure, according to an embodiment.

FIGS. 8A-8G show an apparatus with a ribbed structure subject to elastic deformation, according to an embodiment.

FIGS. 9A-9D show a ribbed structure incorporated into an apparatus, according to an embodiment.

FIG. 10 shows a ribbed structure, according to an embodiment.

FIG. 11 shows a ribbed structure, according to an embodiment.

FIG. 12 shows a ribbed structure, according to an embodiment.

FIGS. 13A-13B show a ribbed structure, according to an embodiment.

FIG. 14 shows a ribbed structure, according to an embodiment.

FIG. 15 shows a method of producing an apparatus including a ribbed structure, according to an embodiment.

FIG. 16 shows a method of producing a ribbed structure, according to an embodiment.

FIGS. 17A-17B show a method of producing a ribbed structure, according to an embodiment.

FIG. 18 shows a plot of transmitted force vs. impact force for apparatuses with and without ribbed structures.

FIG. 19 shows a ribbed structure, according to an embodiment.

### DETAILED DESCRIPTION

Embodiments described herein relate generally to apparatuses, systems, and materials with ribbed structures or geometries for stiffness and damping control, and methods of producing and using the same. In an embodiment, an apparatus includes a ribbed structure with a corrugated pattern, disposed between a first layer and a second layer of lining material. The apparatus with a corrugated pattern can be employed to reduce the material fatigue that occurs when an object experiences shock and/or vibrations. Additionally, the apparatus with a corrugated pattern can reduce discomfort and personal fatigue experienced by a consumer when subject to shock and/or vibrations. The design and physical properties of the apparatus can be catered to deliver the desired damping effects for a given application.

Apparatuses described herein can be useful in many industrial applications. For example, apparatuses with ribbed structures can be useful in applications including roofing, flooring, architectural design, electronics packaging and padding, vibration and shock isolation including the manufacture of vibration isolators and mounts for various industry sectors (e.g., manufacturing, automotive, aerospace, construction, civil infrastructure, etc.) where such apparatuses are used as interfaces between other components to diminish the transmission of shock and vibration, noise isolation, seat systems for comfort, ride quality, and/or occupant safety, and consumer product development for sound and vibration quality and long-life performance.

Corrugated materials are often effective at absorbing fatigue brought on by repeated, low-strain vibrations. This is due to the corrugated materials having a Gaussian curvature of zero or near-zero. Force can be dispersed throughout the corrugated material without compromising the overall structure of the corrugated material. However, commonly used corrugated materials can deform plastically when subject to short, high-strain impact. For example, repeated hail impact on a roof of a house can cause material fatigue, plastic deformation, and eventual visible damage to the roof material. An apparatus with a ribbed structure that deforms elastically under shock can minimize the effects of these impacts and greatly increase the lifetime of the roof material. Such an apparatus can also be used in flooring materials for a similar effect.

With a proper combination of ribbed structure shape, height, material selection, material thickness, corrugated pattern stacking, and ribbed structure pattern, an apparatus that includes a ribbed structure can absorb shock with much more effectiveness than commonly used corrugated materials. Existing corrugated materials have flutes disposed between lining layers. The flutes are strained when subjected to relative strain of the lining layers. All materials have a characteristic stress-strain curve, as well as a zone of elastic deformation and a zone of plastic deformation. Repeated low-stress treatment keeps these corrugated materials in the zone of elastic deformation. However, a sudden high-stress event can cause the material to experience irreversible plastic deformation. Enough such events can eventually cause visible damage to the material and loss of ability to repeatedly absorb future stress loading events.

Ribbed structures (e.g., materials having ribbed geometries) as described herein can have characteristics that differ from existing corrugated materials, e.g., such that the strain is more evenly dispersed throughout various points of the ribbed structure. In other words, rather than having a single maximum strain point midway between a peak and a trough of a ribbed structure, there can be multiple local maximum strain points at several locations of the ribbed structure. The local maximum strain points have a lower strain that the strain at the point midway between a peak and a trough of a flute on a commonly used corrugated material. Similarly, a total height or shape of an apparatus including a ribbed structure can be selected to more evenly disperse the strain along the ribbed structure. In other words, in some embodiments, an apparatus including a ribbed structure can have a maximum strain that exists at points midway between the peaks and troughs of the ribbed structure, but the magnitude of these maxima may decrease, e.g., as the apparatus height increases or shape changes. In some embodiments, stacking multiple ribbed structures together can more evenly distribute the stress and strain along the ribbed structure.

Modifying the ribbed structure material can also improve shock absorption. In some embodiments, using a material with a larger elastic deformation zone can broaden the amount of force that can be applied to the ribbed structure without causing plastic deformation. In some embodiments, thicker materials can be used to produce a similar effect. Stress and strain are inversely proportional to cross sectional area. Using a material with a larger thickness and therefore a larger cross sectional area lowers the incident stress and strain on the material when subject to a force of a given magnitude. In some embodiments, the use of a heterogeneous ribbed structure in an apparatus can improve the overall stability of the apparatus. This heterogeneity can be length-wise (e.g., along the x-axis of the ribbed structure), height-wise (e.g., along the y-axis of the ribbed structure), or depth-wise (e.g., along the z-axis of the ribbed structure). Heterogeneity, in some instances, can prevent shear movement of an apparatus including such a ribbed structure. An example of shear exists when a large load is applied to an object with corrugated material (e.g., a yard sign). When stepping on a yard sign, the yard sign can shift such that the top layer moves laterally and downward, temporarily flattening the sign. If a first section of the sign has a series of sinusoidal curves with a slight diagonal shift to the left and a second section of the ribbed structure has a series of sinusoidal curves with a slight diagonal shift to the right, this heterogeneity can provide a resistance to shear. The second section of the ribbed structure behaves out-of-phase from the first section of the ribbed structure. When a force is applied, the second section of the ribbed structure may experience a lower maximum strain than the first section of the ribbed structure or vice versa.

In some embodiments, an apparatus including a ribbed structure, as described in embodiments presented herein, can damp forces associated with a shock, e.g., forces lasting during a short time interval generated by a transient event (e.g., an impact, an explosion, etc.). In some embodiments, the forces associated with a shock can have a magnitude of at least about a few hundred Newton (e.g., 200 N, at least about 300 N, at least about 400 N, at least about 500 N, at least about 600 N, at least about 700 N, at least about 800 N, or at least about 900 N). In some embodiments, the forces can have a magnitude of no more than about 35,000 N, no more than about 30,000 N, no more than about 25,000 N, no more than about 20,000 N, no more than about 15,000 N, no more than about 10,000 N, no more than about 5,000 N, no more than about 1,000 N, no more than about 900 N, no more than about 800 N, no more than about 700 N, no more than about 600 N, no more than about 500 N, no more than about 400 N, or no more than about 300 N. Combinations of the above-referenced ranges are also possible (e.g., at least about 200 N to no more than about 1,000 N, or at least about 300 N to no more than about 500 N), inclusive of all values and ranges therebetween. In some embodiments, an apparatus including a ribbed structure can damp forces associated with a shock that have a magnitude of about 200 N, about 300 N, about 400 N, about 500 N, about 600 N, about 700 N, about 800 N, about 900 N, about 1,000 N, about 5,000 N, about 10,000 N, about 15,000 N, about 20,000 N, about 25,000 N, about 30,000 N, or about 35,000 N.

In some embodiments, the time interval associated with a shock can be at least about 1 ms, at least about 2 ms, at least about 3 ms, at least about 4 ms, at least about 5 ms, at least about 6 ms, at least about 7 ms, at least about 8 ms, or at least about 9 ms, In some embodiments, the time interval can be no more than about 10 ms, no more than about 9 ms, no more than about 8 ms, no more than about 7 ms, no more than about 6 ms, no more than about 5 ms, no more than about 4 ms, no more than about 3 ms, or no more than about 2 ms. Combinations of the above-referenced ranges are also possible (e.g., at least about 1 ms to no more than about 10 ms, or at least about 2 ms to no more than about 5 ms), inclusive of all values and ranges therebetween. In some embodiments, the time interval can be about 1 ms, about 2 ms, about 3 ms, about 4 ms, about 5 ms, about 6 ms, about 7 ms, about 8 ms, about 9 ms, or about 10 ms,

Examples of apparatus with damping properties are described in U.S. Pat. No. 10,458,501 entitled, “Designs and Manufacturing Methods for Lightweight Hyperdamping Materials Providing Large Attenuation of Broadband-Frequency Structure-Borne Sound,” filed Mar. 2, 2017 (“the '501 patent”), the disclosure of which is incorporated herein by reference in its entirety.

The term “substantially” when used in connection with “cylindrical,” “linear,” and/or other geometric relationships is intended to convey that the structure so defined is nominally cylindrical, linear or the like. As one example, a portion of a support member that is described as being “substantially linear” is intended to convey that, although linearity of the portion is desirable, some non-linearity can occur in a “substantially linear” portion. Such non-linearity can result from manufacturing tolerances, or other practical considerations (such as, for example, the pressure or force applied to the support member). Thus, a geometric construction modified by the term “substantially” includes such geometric properties within a tolerance of plus or minus 5% of the stated geometric construction. For example, a “substantially linear” portion is a portion that defines an axis or center line that is within plus or minus 5% of being linear.

As used herein, the term “set” and “plurality” can refer to multiple features or a singular feature with multiple parts. For example, when referring to a set of electrodes, the set of electrodes can be considered as one electrode with multiple portions, or the set of electrodes can be considered as multiple, distinct electrodes. Additionally, for example, when referring to a plurality of electrochemical cells, the plurality of electrochemical cells can be considered as multiple, distinct electrochemical cells or as one electrochemical cell with multiple portions. Thus, a set of portions or a plurality of portions may include multiple portions that are either continuous or discontinuous from each other. A plurality of particles or a plurality of materials can also be fabricated from multiple items that are produced separately and are later joined together (e.g., via mixing, an adhesive, or any suitable method).

As used herein with reference to a ribbed structure or apparatus, “x-axis” or “x-direction” refers to the horizontal direction when viewing a ribbed structure from a front or back side. In other words, when viewing the apparatus from such a perspective that the first layer of material is above the ribbed structure and the second layer of material is below the ribbed structure, the x-axis extends from left to right.

As used herein with reference to a ribbed structure or apparatus, “y-axis” or “y-direction” refers to the vertical direction when viewing a ribbed structure from a front or back side. In other words, when viewing the apparatus from such a perspective that the first layer of material is above the ribbed structure and the second layer of material is below the ribbed structure, the y-axis extends from top to bottom.

As used herein with reference to a ribbed structure or apparatus, “z-axis” or “z-direction” refers to the depth direction (i.e., into and out of the viewing plane) when viewing a ribbed structure from a front or back side. In other words, when viewing the ribbed structure from such a perspective that the first layer of material is above the ribbed structure and the second layer of material is below the ribbed structure, the z-axis extends toward the viewer and away from the viewer.

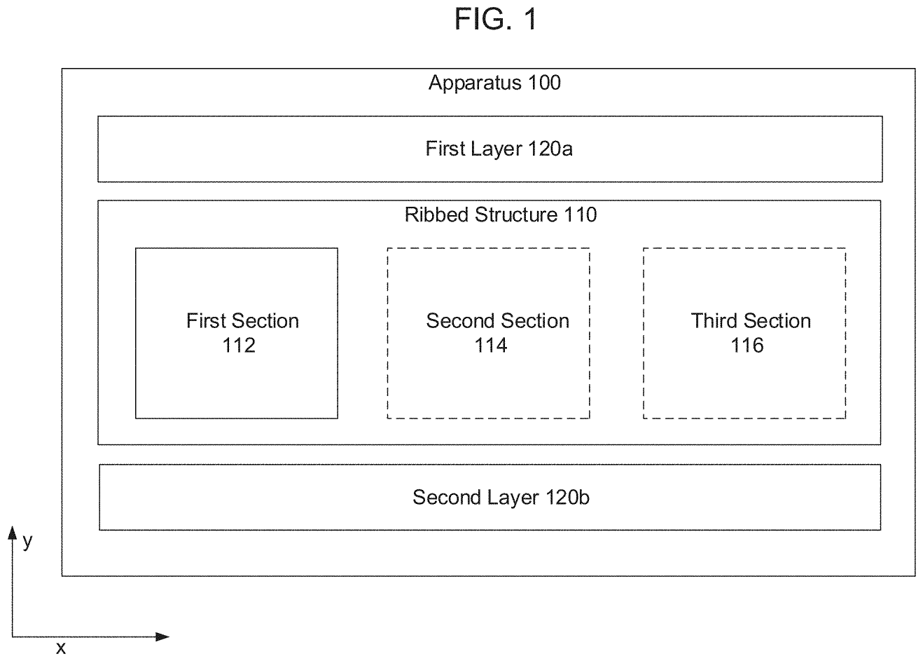

FIG. 1 shows a schematic illustration of an apparatus 100 with damping control, according to an embodiment. The apparatus 100 includes a ribbed structure 110 including a set of ribs. In some embodiments, the apparatus 100 can optionally include a first layer 120a (e.g., flat structure, material, etc.) coupled to a first side of the ribbed structure 110, and a second layer 120b (e.g., flat structure, material, etc.) coupled to a second side of the ribbed structure. As shown, the ribbed structure 110 includes a first section 112 with a first set of physical and mechanical properties. In some embodiments, the ribbed structure can include a second section 114 with a second set of physical and mechanical properties, wherein the second set of physical and mechanical properties are different from the first set of physical and mechanical properties. In some embodiments, the ribbed structure can include a third section 116 with a third set of physical and mechanical properties, wherein the third set of mechanical properties are different from the first and second set of physical and mechanical properties. In some embodiments, the ribbed structure 110 can include additional sections (i.e., a fourth section, a fifth section, a sixth section, a seventh section, an eighth section, a ninth section, a tenth section, or more) with additional sets of physical and mechanical properties. In some embodiments, the ribbed structure 110 can include repeating sequences of sections with specific sets of physical and mechanical properties. In other words, the ribbed structure can include the first section 112, the second section 114, the third section 116, an additional section with properties similar to the first section 112, an additional section with properties similar to the second section 114, an additional section with properties similar to the third section 116, and repeat this pattern. The apparatus 100 exhibits elastic deformation or substantially elastic deformation when subject to shock, vibrations, loads, etc.

In some embodiments, the apparatus 100 can have a height of at least about 1 mm, at least about 2 mm, at least about 3 mm, at least about 4 mm, at least about 5 mm, at least about 6 mm, at least about 7 mm, at least about 8 mm, at least about 9 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the apparatus 100 can have a height of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 9 mm, no more than about 8 mm, no more than about 7 mm, no more than about 6 mm, no more than about 5 mm, no more than about 4 mm, no more than about 3 mm, or no more than about 2 mm. Combinations of the above-referenced ranges for the height of the apparatus 100 are also possible (e.g., at least about 1 mm and no more than about 5 cm or at least about 2 cm and no more than about 4 cm). In some embodiments, the apparatus 100 can have a height of about 1 mm, about 2 mm, about 3 mm, about 4 mm, about 5 mm, about 6 mm, at least about 7 mm, at least about 8 mm, at least about 9 mm about 1 cm, about 1.5 cm, about 2 cm, about 2.5 cm, about 3 cm, about 3.5 cm, about 4 cm, about 4.5 cm, or about 5 cm. In some embodiments, the apparatus 100 can have a height that is heterogeneous along the x-axis. In some embodiments, the apparatus 100 can have a height that changes gradually along the x-axis. In some embodiments, the apparatus 100 can have a height that changes sharply along the x-axis.

In some embodiments, each section of the ribbed structure 110 can have a characteristic material composition. In some embodiments, the ribbed structure 110 or a section of the ribbed structure 110 can be composed of polypropylene, polyethylene, polyolefin, polycarbonate, polyvinyl chloride, nylon, a composite material, an elastomer, a vulcanized rubber, or any other suitable material, or any combination of such materials. In some embodiments, the first section 112 can be composed of a first material and the second section 114 can be composed of a second material, the second material being different from the first material. In some embodiments, the third section 116 can be composed of a third material, the third material being different from the first material and the second material. In some embodiments, additional sections can be composed of the same or different materials.

In some embodiments, the ribbed structure 110 or a section of the ribbed structure 110 can have a material thickness of at least about 0.25 mm, at least about 0.5 mm, at least about 0.75 mm, at least about 1 mm, at least about 1.25 mm, at least about 1.5 mm, or at least about 1.75 mm. In some embodiments, the ribbed structure 110 or a section of the ribbed structure 110 can have a material thickness of no more than about 2 mm, no more than about 1.75 mm, no more than about 1.5 mm, no more than about 1.25 mm, no more than about 1 mm, no more than about 0.75 mm, or no more than about 0.5 mm. Combinations of the above-referenced ranges for the thickness of the ribbed structure 110 or a section of the ribbed structure 110 are also possible (e.g., at least about 0.25 mm to no more than about 2 mm, or at least about 0.5 mm to no more than about 1.5 mm), inclusive of all values and ranges therebetween. In some embodiments, the ribbed structure 110 or a section of the ribbed structure 110 can have a material thickness of about 0.25 mm, about 0.5 mm, about 0.75 mm, about 1 mm, about 1.25 mm, about 1.5 mm, about 1.75 mm, or about 2 mm. In some embodiments, the first section 112 can have a first material thickness, and the second section 114 can have a second material thickness, the second material thickness being different from the first material thickness. In some embodiments, the third section 116 can have a third material thickness, the third material thickness being different from the first material thickness and the second material thickness. In some embodiments, additional sections can have the same and/or different material thickness values.

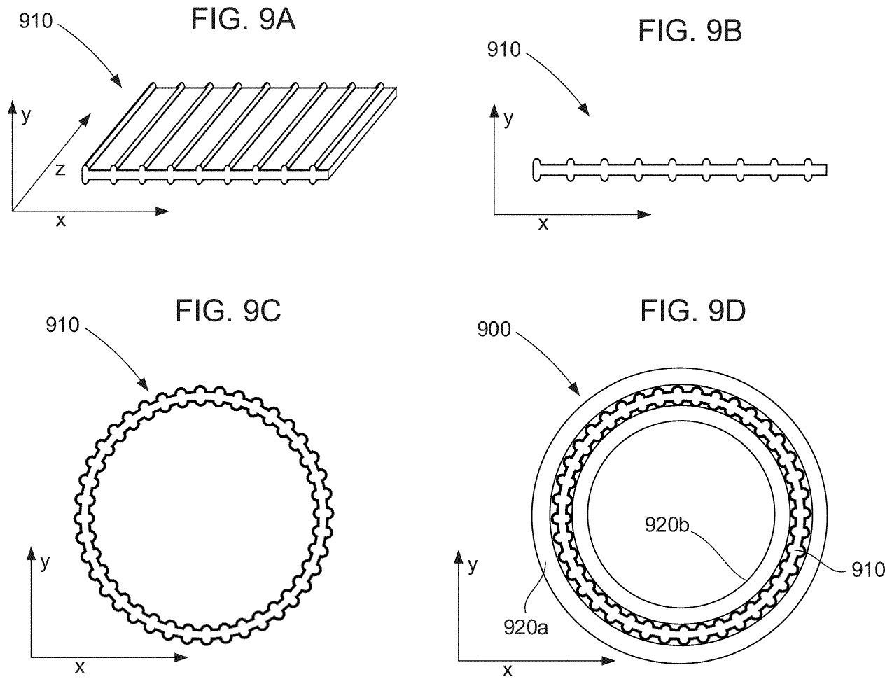

In some embodiments, the ribbed structure 110 or a section of the ribbed structure 110 can have a distinctive shape (e.g., a wave shape) exhibited along the x-axis and/or y-axis of the ribbed structure 110, or along a lateral plane of the ribbed structure (e.g., an x-z plane). In some embodiments, the ribbed structure 110 or a section of the ribbed structure 110 can have a smooth sinusoidal shape, a rectangular wave shape, a square wave shape, a triangular wave shape, a sinusoidal shape with square or blocky edges, a shape with multiple local maximum y-axis values and one absolute maximum y-axis value (i.e., a shape with multiple peak positions), a sawtooth wave shape, a jagged irregular shape, or any other suitable shape to effectively disperse the strain along the ribbed structure 110. The periodicity of the ribbed structure 110 can be viewed as the set of ribs of the ribbed structure 110. In some embodiments, the first section 112 can have a first wave shape (e.g., a first set of ribs that exhibits a first set of characteristics), and the second section 114 can have a second wave shape (e.g., a second set of ribs that exhibits a second set of characteristics), the second wave shape being different from the first wave shape (e.g., the second set of characteristics of the second set of ribs being different from the first set of characteristics of the first set of ribs. In some embodiments, the third section 116 can have a third wave shape, the third wave shape being different from the first wave shape and the second wave shape. In some embodiments, additional sections can have the same and/or different wave shapes. In other words, the ribbed structure 110 can have a shape formed by the addition of multiple wave shapes, such that the ribbed structure has multiple wavelengths. For example, if two sine waves with different wave shapes are added together, the resulting wave shape has an absolute maximum value, and multiple occurrences of local maxima or “sub-peaks” between each occurrence of the absolute maximum value. Stated differently, if two sine waves with different wave shapes are added together, the resulting ribbed structure can have a set of ribs that each have an absolute maximum value, an absolute minimum value, and one or more local maxima and minima between the absolute maximum and minimum values. In some embodiments, the resulting wave shape can be formed by the addition of three, four, five, six, seven, eight, nine, ten, or more wave shapes. In some embodiments, the ribbed structure 110 can include ribs (e.g., projections) that extend outwardly (e.g., perpendicular or set at a non-zero angle) from a flat surface or layer, as further detailed below with respect to FIGS. 9A-12.

In some embodiments, the ribbed structure 110 or a section of the ribbed structure 110 can have an amplitude. The amplitude, for example, can be the value along the y-direction between a peak and the next trough that follows the peak along the x-axis. In other words, amplitude can be the ribbed structure's height along the y-axis. For example, if a peak is higher than a trough by 1 cm along the y-axis, the amplitude used to describe the ribbed structure is 1 cm. In some embodiments, the ribbed structure 110 or a section of the ribbed structure 110 can have an amplitude of at least about 0.5 mm, at least about 1 mm, at least about 2 mm, at least about 3 mm, at least about 4 mm, at least about 5 mm, at least about 1 cm, at least about 1.5 cm, at least about 2 cm, at least about 2.5 cm, at least about 3 cm, at least about 3.5 cm, at least about 4 cm, or at least about 4.5 cm. In some embodiments, the ribbed structure 110 or a section of the ribbed structure 110 can have an amplitude of no more than about 5 cm, no more than about 4.5 cm, no more than about 4 cm, no more than about 3.5 cm, no more than about 3 cm, no more than about 2.5 cm, no more than about 2 cm, no more than about 1.5 cm, no more than about 1 cm, no more than about 5 mm, no more than about 4 mm, no more than about 3 mm, no more than about 2 mm, or no more than about 1 mm. Combinations of the above-referenced ranges for the amplitude of the ribbed structure 110 or a section of the ribbed structure 110 are also possible (e.g., at least about 0.5 mm to no more than about 5 cm, or at least about 1 cm to no more than about 4 cm) inclusive of all values and ranges therebetween. In some embodiments, the ribbed structure 110 or a section of the ribbed structure 110 can have an amplitude of about 0.5 mm, about 1 mm, about 2 mm, about 3 mm, about 4 mm, about 5 mm, about 1 cm, about 1.5 cm, about 2 cm, about 2.5 cm, about 3 cm, about 3.5 cm, about 4 cm, about 4.5 cm, or about 5 cm. In some embodiments, the first section 112 can have a first amplitude, and the second section 114 can have a second amplitude, the second amplitude being different from the first amplitude. In some embodiments, the third section 116 can have a third amplitude, the third amplitude being different from the first amplitude and the second amplitude. In some embodiments, additional sections can have the same and/or different amplitudes.

In some embodiments, the ribbed structure 110 or a section of the ribbed structure 110 can have a distinctive peak-to-peak period. In some embodiments, the ribbed structure 110 or a section of the ribbed structure 110 can have a wavelength of at least about 2 mm, at least about 3 mm, at least about 4 mm, at least about 5 mm, at least about 6 mm, at least about 7 mm, at least about 8 mm, or at least about 9 mm. In some embodiments, the ribbed structure 110 or a section of the ribbed structure 110 can have a peak-to-peak period of no more than about 1 cm, no more than about 9 mm, no more than about 8 mm, no more than about 7 mm, no more than about 6 mm, no more than about 5 mm, no more than about 4 mm, or no more than about 3 mm. Combinations of the above-referenced ranges for the peak-to-peak period of the ribbed structure 110 or a section of the ribbed structure 110 are also possible (e.g., at least about 2 mm to no more than about 1 cm, or at least about 3 mm to no more than about 8 mm) inclusive of all values and ranges therebetween. In some embodiments, the ribbed structure 110 or a section of the ribbed structure 110 can have a peak-to-peak period of about 2 mm, about 3 mm, about 4 mm, about 5 mm, about 6 mm, about 7 mm, about 8 mm, about 9 mm, or about 1 cm. In some embodiments, the first section 112 can have a first peak-to-peak period, and the second section 114 can have a second peak-to-peak period, the second peak-to-peak period being different from the first peak-to-peak period. In some embodiments, the third section 116 can have a third peak-to-peak period, the third wavelength being different from the first peak-to-peak period and the second peak-to-peak period. In some embodiments, additional sections can have the same and/or different peak-to-peak periods.

In some embodiments, the ribbed structure 110 can be homogeneous along the x-axis. In other words, the ribbed structure 110 can have a wave shape, material thickness, amplitude, and wavelength that do not change along the x-axis. In some embodiments, the ribbed structure 110 can be gradually heterogeneous along the x-axis. In other words, the ribbed structure 110 can have gradual changes in wave shape, material thickness, amplitude, and/or wavelength along the x-axis, rather than being divided into discrete sections. In some embodiments, the ribbed structure 110 can include transition regions between sections. For example, a transition region between the first section 112 and the second section 114 can have a wave shape that is a hybrid between the wave shape of the first section 112 and the second section 114. If the first section 112 has a smooth sinusoidal wave shape and the second section 114 has a square wave shape, the transition region between the first section 112 and the second section 114 can have a blockier sinusoidal wave shape, gradually changing from the smooth sinusoidal wave shape to the square wave shape. Similarly, the transition region can have a material thickness, amplitude, and/or wavelength that change gradually between the first section 112 and the second section 114.

In some embodiments, the apparatus 100 can include a single ribbed structure 110. In some embodiments, the apparatus 100 can include multiple ribbed structures 110, e.g., stacked upon each other. In other words, the apparatus 100 can include multiple layers of ribbed structures 110, wherein the peaks of a first ribbed structure are coupled to the troughs of a second ribbed structure, the second ribbed structure being placed directly above the first ribbed structure along the y-axis. In some embodiments, the apparatus 100 can include 3, 4, 5, 6, 7, 8, 9, 10, or more ribbed structures stacked upon each other. In some embodiments, ribbed structures stacked upon each other can have the same or substantially similar physical properties (e.g., material, material thickness, wave shape, amplitude, wavelength, etc.). In some embodiments, ribbed structures stacked upon each other can be different from each other in terms of physical properties.

In some embodiments, the apparatus 100 can optionally include a first layer 120a and a second layer 120b (collectively referred to as outer layers 120), disposed on either side of the ribbed structure 110 along the y-axis. The outer layers 120 can offer an additional layer of protection from shock. While the vast majority of the shock is incident upon the ribbed structure 110, the outer layers 120 can also absorb a small amount of force, reducing the burden on the ribbed structure 110. Additionally, the outer layers 120 can improve the stackability, transportability, and adaptability of the apparatus 100. In other words, having relatively flat surfaces on either side of the ribbed structure 110 can allow multiple apparatus 100 to be stacked without the ribbed structures 110 of the apparatus 100 damaging each other. Additionally, an object placed upon either of the outer layers 120 can more easily conform to the relatively flat surfaces of the outer layers 120 than to the ribbed structure 110. For example, when an apparatus 100 is placed below the shingles on the roof of a house, it is more practical and aesthetically desirable for the shingles to be disposed onto the relatively flat surface of the first layer 120a than the disorderly surface of the ribbed structure 110. While the first and second layers 120a, 120b are schematically depicted as extending along a single axis or in a planar direction, it can be appreciated that layers 120a, 120b can extend in additional directions and/or in curved (e.g., circular) or angled configurations.

In some embodiments, the first layer 120a and/or the second layer 120b can be composed of polypropylene, polyethylene, polyolefin, polycarbonate, polyvinyl chloride, nylon, a composite material, an elastomer, a vulcanized rubber, or any other suitable material. In some embodiments, the first layer 120a and/or the second layer 120b can be composed of the same or a substantially similar material as the ribbed structure 110. In some embodiments, the first layer 120a and/or the second layer 120b can be composed of materials different from the ribbed structure 110. In some embodiments, the ribbed structure 110 can be coupled to the first layer 120a and/or the second layer via adhesives, fasteners, or any other suitable coupling means or combinations thereof.

In some embodiments, the first layer 120a and/or the second layer 120b can have a material thickness of at least about 0.1 mm, at least about 0.2 mm, at least about 0.25 mm, at least about 0.5 mm, at least about 0.75 mm, at least about 1 mm, at least about 1.25 mm, at least about 1.5 mm, or at least about 1.75 mm. In some embodiments, the first layer 120a and/or the second layer 120b can have a material thickness of no more than about 2 mm, no more than about 1.75 mm, no more than about 1.5 mm, no more than about 1.25 mm, no more than about 1 mm, no more than about 0.75 mm, no more than about 0.5 mm, no more than about 0.25 mm, or no more than about 0.2 mm. Combinations of the above-referenced ranges for the thickness of the first layer 120a and/or the second layer 120b are also possible (e.g., at least about 0.1 mm to no more than about 2 mm, or at least about 0.5 mm to no more than about 1.5 mm), inclusive of all values and ranges therebetween. In some embodiments, the first layer 120a and/or the second layer 120b can have a material thickness of about 0.1 mm, about 0.2 mm, about 0.25 mm, about 0.5 mm, about 0.75 mm, about 1 mm, about 1.25 mm, about 1.5 mm, about 1.75 mm, or about 2 mm.

In some embodiments, the first layer 120a can have the same or substantially similar physical properties (e.g., material composition, thickness) to the second layer 120b. In some embodiments, the first layer 120a can have a first set of physical properties, while the second layer 120b can have a second set of physical properties, wherein the second set of physical properties is different from the first set of physical properties. In some embodiments, the physical properties of the first layer 120a and/or the second layer 120b can be homogeneous along the x-axis. In some embodiments, the physical properties of the first layer 120a and/or the second layer 120b can change gradually along the x-axis. In some embodiments, the physical properties of the first layer 120a and/or the second layer 120b can change suddenly along the x-axis.

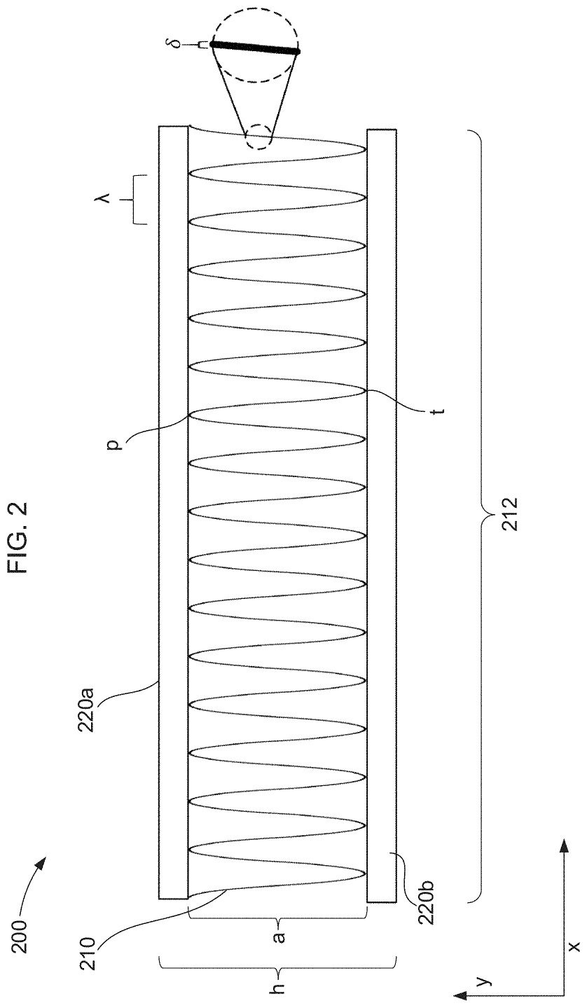

FIG. 2 shows an apparatus 200 with a ribbed structure 210 including a set of ribs, according to an embodiment. The apparatus 200 includes a ribbed structure 210 with a first section 212, coupled to a first layer 220a and a second layer 220b. The ribbed structure 210 is substantially homogeneous along the x-axis. The apparatus 200 has a characteristic height h. The ribbed structure 210 has characteristic peaks p and troughs t.

As shown, the height h refers to the distance along the y-axis from the top of the apparatus 200 to the bottom of the apparatus 200. As shown, the peaks p are points on the ribbed structure 210, at which the ribbed structure 210 has a y-axis value that reaches a local maximum. In other words, the peaks p are points, at which moving to the left or the right along the x-axis results in a decrease in the y-value of the ribbed structure 210. As shown, the troughs t are points on the ribbed structure 210, at which the ribbed structure 210 has a y-axis value reaches a local minimum. In other words, the troughs are points, at which moving to the left or the right along the x-axis results in an increase in the y-value of the ribbed structure 210. The ribbed structure 210 also has a characteristic amplitude a, wavelength λ, and thickness δ. As shown, the thickness δ can be the distance along the y-axis from the top surface of a ribbed structure 210 at a particular point to the bottom surface of the ribbed structure 210 at that point. As shown, the ribbed structure 210 has a repeating sinusoidal pattern. Given the consistently repeating pattern along the x-axis, the ribbed structure 210 can be described as homogeneous, and the wavelength λ, of the ribbed structure 210 is equal to the peak-to-peak period of the ribbed structure 210. In some embodiments, the ribbed structure 210, the first section, 212, the first layer 220a, and the second layer 220b can have the same or substantially similar physical and mechanical properties to the ribbed structure 110, the first section 112, the first layer 120a, and the second layer 120b as described above with reference to FIG. 1.

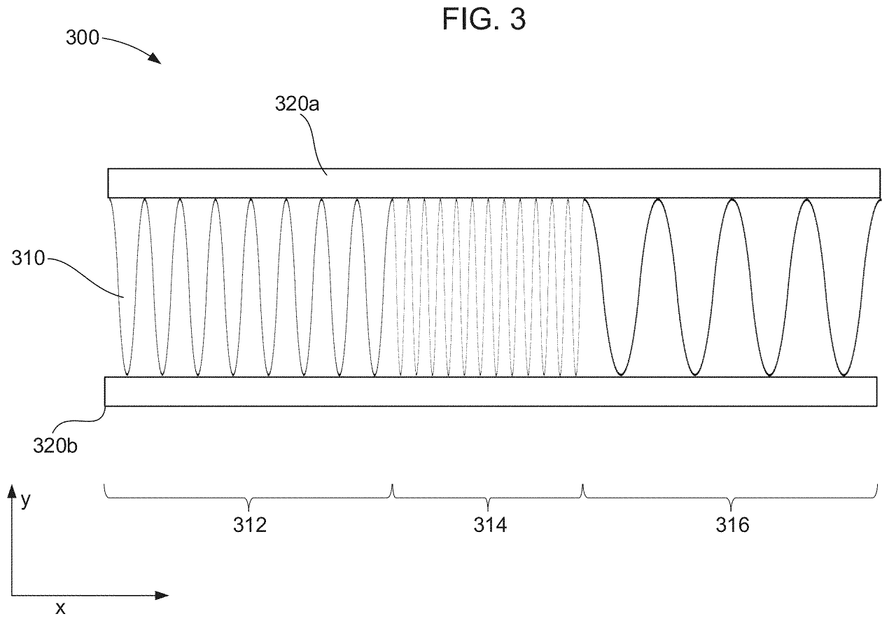

FIG. 3 shows an apparatus 300 with a ribbed structure 310, according to an embodiment. The ribbed structure 310 is coupled to a first layer 320a and a second layer 320b. As shown, the ribbed structure 310 includes a first section 312, a second section 314, and a third section 316. Each of the three sections includes a sinusoidal pattern. As shown, the ribbed structure 310 has heterogeneity in frequency along the x-axis, e.g., the second section 314 has a higher frequency than the first section 312 and the third section 316 has a lower frequency than the first section 312. Heterogeneity in frequency along the x-axis can help limit or reduce shear deformation. In some embodiments, the first section 312, the second section 314, and the third section 316 can have frequencies selected such that ribbed structure 310 is highly resistant to shear deformation. The magnitude and/or direction of a shear force required to subject each section of the ribbed structure 310 to shear deformation is a function of the frequency of each section. Therefore, the use of sections with varying frequencies along the x-axis of the ribbed structure 310 can prevent a single force vector from deforming the entire ribbed structure 310. In other words, a force vector may of the sufficient magnitude in a direction to cause shear deformation to the first section 312 may not be of sufficient magnitude in that direction to cause shear deformation to the second section 314 or the third section 316. In such a case, the second section 314 and the third section 316 aid in resisting shear deformation of the apparatus 300.

While sections 312, 314, 316 are depicted in FIG. 3 as each having a different frequency, it can be appreciated that multiple sections of a ribbed structure can share the same frequency and/or have different frequency. For example, sections 312 and 316, in other embodiments, can have the same frequency but both have a different frequency from section 314. Other combinations of sections can also be used to improve an apparatus's resistance to shear forces and/or to account for different types of expected loads, e.g., based on a specific application.

In some embodiments, the ribbed structure 310, the first section, 312, the second section 314, the third section 316, the first layer 320a, and the second layer 320b can have the same or substantially similar physical and mechanical properties to the ribbed structure 110, the first section 112, the second section 114, the third section 116, the first layer 120a, and the second layer 120b as described above with reference to FIG. 1.

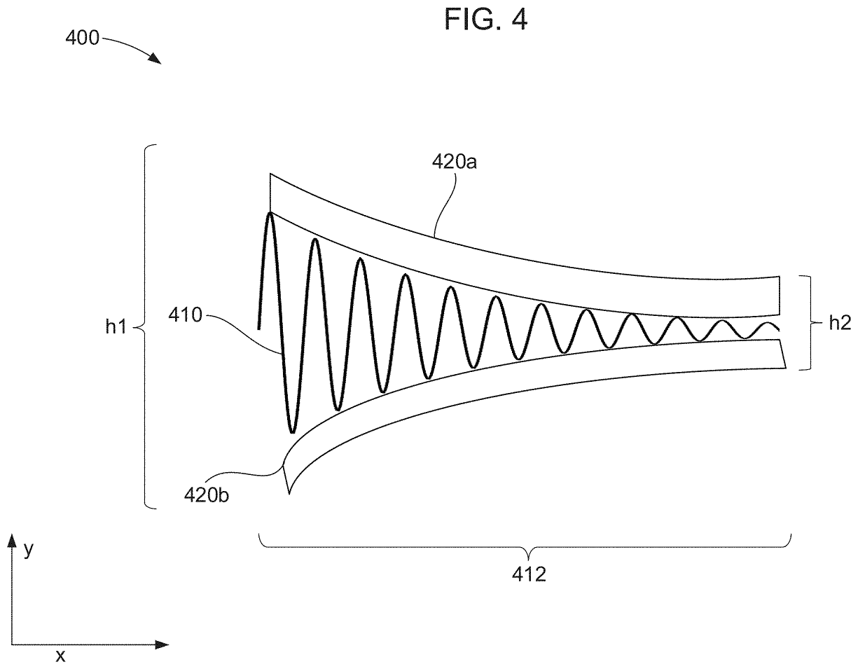

FIG. 4 shows an apparatus 400 with a ribbed structure 410, according to an embodiment. The ribbed structure 410 is coupled to a first layer 420a and a second layer 420b. As shown, the ribbed structure 410 includes a first section 412 that is associated with a constant frequency along the x-axis. The apparatus 400 has a first height h1 on a first side and a second height h2 on a second side. The ribbed structure 410 has a sinusoidal structure that damps along the x-axis. In other words, h2 is less than h1. In some embodiments, the height of the apparatus 400 can re-expand from a value of h2 to a value of h1 when moving further to the right along the x-axis, and repeat this pattern. In other words, the apparatus 400 can have a height that changes along the x-axis in a repeating, sinusoidal pattern.

In some embodiments, the ratio of h1:h2 can be at least about 1:1, at least about 1.1:1, at least about 1.2:1, at least about 1.3:1, at least about 1.4:1, at least about 1.5:1, at least about 1.6:1, at least about 1.7:1, at least about 1.8:1, at least about 1.9:1, at least about 2:1, at least about 3:1, at least about 4:1, at least about 5:1, at least about 6:1, at least about 7:1, at least about 8:1, or at least about 9:1. In some embodiments, the ratio of h1:h2 can be no more than about 10:1, no more than about 9:1, no more than about 8:1, no more than about 7:1, no more than about 6:1, no more than about 5:1, no more than about 4:1, no more than about 3:1, no more than about 2:1, no more than about 1.9:1, no more than about 1.8:1, no more than about 1.7:1, no more than about 1.6:1, no more than about 1.5:1, no more than about 1.4:1, no more than about 1.3:1, no more than about 1.2:1, or no more than about 1.1:1. Combinations of the above-referenced ranges for the ratio of h1:h2 are also possible (e.g., at least about 1:1 and no more than about 10:1 or at least about 1.5:1 and no more than about 5:1), inclusive of all values and ranges therebetween. In some embodiments, the ratio of h1:h2 can be about 1:1, about 1.1:1, about 1.2:1, about 1.3:1, about 1.4:1, about 1.5:1, about 1.6:1, about 1.7:1, about 1.8:1, about 1.9:1, about 2:1, about 3:1, about 4:1, about 5:1, about 6:1, about 7:1, about 8:1, about 9:1, or about 10:1.

In some embodiments, the ribbed structure 410, the first section, 412, the first layer 420a, and the second layer 420b can have the same or substantially similar physical and mechanical properties to the ribbed structure 110, the first section 112, the first layer 120a, and the second layer 120b as described above with reference to FIG. 1.

Ribbed structure 410 can be used in applications with varying dimensional requirements. For example, ribbed structure 410 can be specifically constructed for areas and/or spaces, e.g., between first and second portions 420a, 420b, that vary in height in one or more directions. Having a ribbed structure that is adapted to the varying height can further improve mechanical properties, e.g., including shock absorption.

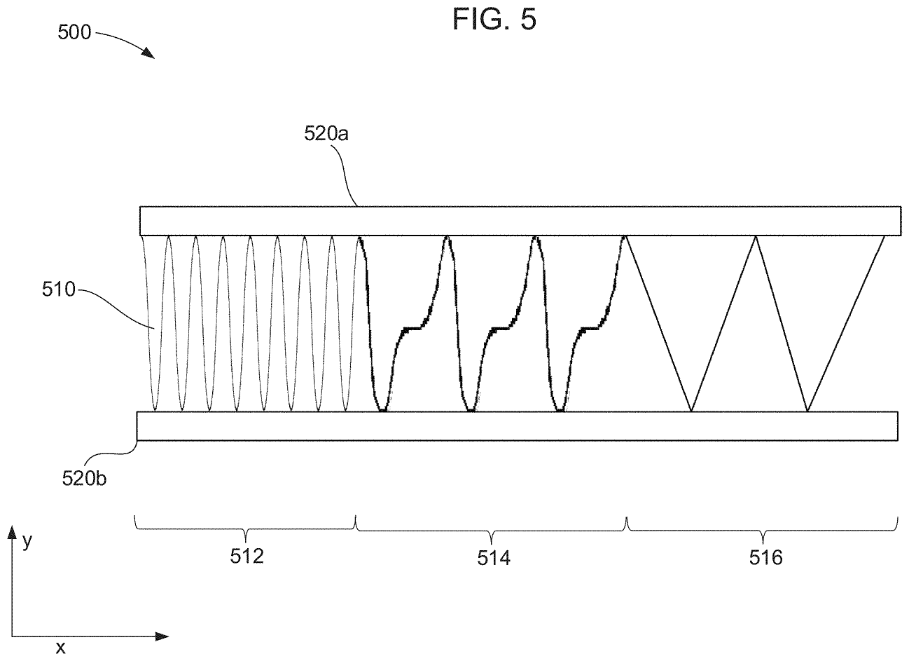

FIG. 5 shows an apparatus 500 with a ribbed structure 510, according to an embodiment. The ribbed structure 510 is coupled to a first layer 520a and a second layer 520b. As shown, the ribbed structure 510 includes a first section 512, a second section 514, and a third section 516, wherein the first section 512, the second section 514, and the third section 516 have differing wave shapes. In other words, the ribbed structure 510 behaves heterogeneously along the x-axis. As shown, the first section 512 has a smooth sinusoidal wave shape, the second section 514 has a wave shape that can result from the addition of multiple sinusoidal waves, and the third section 516 has a triangular wave shape. Any combination of the aforementioned wave shapes, or other shapes, are possible. In some embodiments, the first section 512 can have a first material thickness and the second section 514 can have a second material thickness, the second material thickness different from the first material thickness. In some embodiments, the third section 516 can have a third material thickness, the third material thickness different from the first material thickness and the second material thickness. In some embodiments, the first section 512, the second section 514, and the third section 516 can have wave shapes selected such that no more than one of the three sections experiences a maximum strain caused by force incident on the apparatus 500. In some embodiments, the first section 512, the second section 514, and the third section 516 can have wave shapes selected such that the apparatus 500 is highly resistant to shear deformation, similar to that described above with reference to FIG. 3. In some embodiments, the ribbed structure 510 can include additional sections with additional wave or other shapes. In some embodiments, the ribbed structure 510 can include multiple sections substantially similar to the first section 512, the second section 514, and/or the third section 516.

In some embodiments, the ribbed structure 510, the first section, 512, the second section 514, the third section 516, the first layer 520a, and the second layer 520b can have the same or substantially similar physical and mechanical properties to the ribbed structure 110, the first section 112, the second section 114, the third section 116, the first layer 120a, and the second layer 120b as described above with reference to FIG. 1.

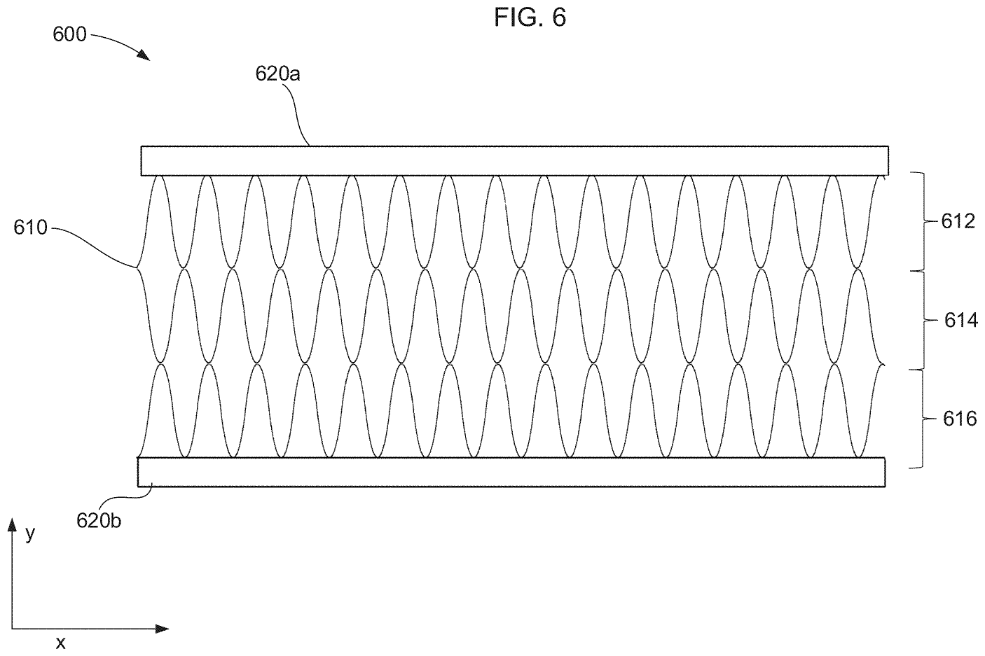

FIG. 6 shows an apparatus 600 with a ribbed structure 610, according to an embodiment. The ribbed structure 610 is coupled to a first layer 620a and a second layer 620b. As shown, the ribbed structure 610 includes a first section 612, a second section 614, and a third section 616, wherein the first section 612, the second section 614, and the third section 616 are stacked upon each other (e.g., arranged along the y-axis relative to each other). As shown, the troughs of the first section 612 are coupled to the peaks of the second section 614 and the troughs of the second section 614 are coupled to the peaks of the third section 616. In some embodiments, the ribbed structure 610 can include additional layers with the troughs of each section coupled to the peaks of each subsequent section. Stacking the sections of the ribbed structure 610 can further enhance the shock absorption properties of the ribbed structure 610. This stacked arrangement can further dissipate stress and further assist in keeping each of the layers of the ribbed structure 610 in a plastic deformation regime upon the application of shock to the apparatus 600.

In some embodiments, the coupling locations of each section to each subsequent section can be points that are not troughs or peaks. In other words, the first section 612 can be shifted slightly to the left or right along the x-axis, such that a point on the surface of the first section 612 other than the trough is coupled to a point on the surface of the second section 614 other than the peak. In some embodiments, the couplings between each section and each subsequent section can be achieved via adhesives, fasteners, or any other suitable coupling means or combinations thereof. In some embodiments, the sections can be formed (e.g., molded) as a unitary component, and coupling points between the various sections be formed of continuous material.

In some embodiments, stacking the first section 612 on top of the second section 614 and stacking the second section 614 on top of the third section 616 can soften the spring effect of the apparatus 600. In other words, the effect of multiple layers of the ribbed structure 610 stacked on top of one another can reduce the stiffness of the ribbed structure 610, when compared to a ribbed structure with a single layer.

In some embodiments, the apparatus 600, the ribbed structure 610, the first section, 612, the second section 614, the third section 616, the first layer 620a, and the second layer 620b can have the same or substantially similar physical and mechanical properties to the apparatus 100, ribbed structure 110, the first section 112, the second section 114, the third section 116, the first layer 120a, and the second layer 120b as described above with reference to FIG. 1.

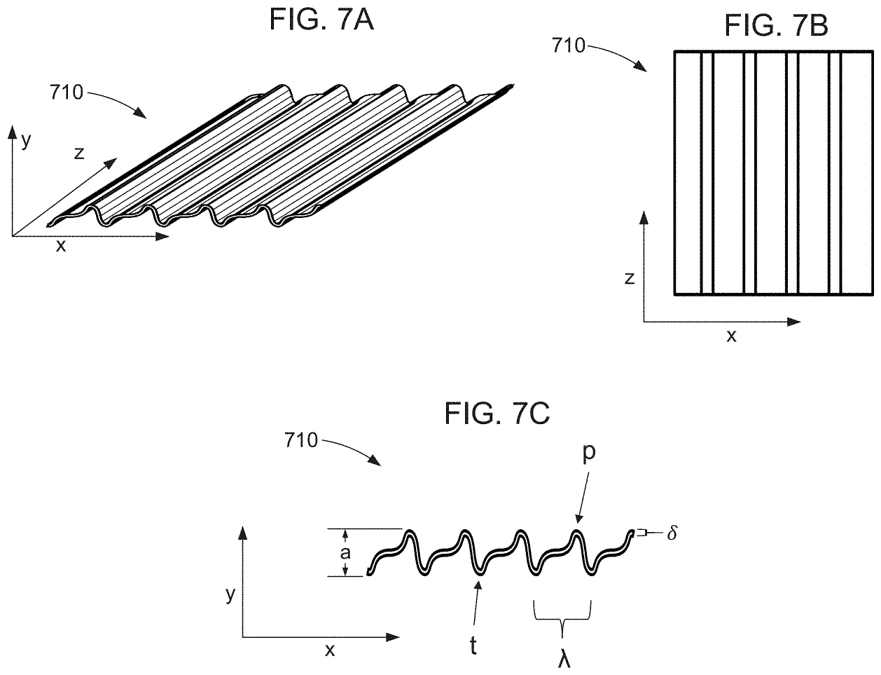

FIGS. 7A-7C show a ribbed structure 710 including a set of ribs from multiple perspectives, according to an embodiment. FIG. 7A shows an auxiliary view of the ribbed structure 710, FIG. 7B shows an overhead view of the ribbed structure 710, and FIG. 7C shows a side view or cross-sectional view of the ribbed structure 710. As shown, the ribbed structure 710 has a characteristic amplitude a, peak-to-peak period λ, and thickness δ. The ribbed structure 710 also has characteristic peaks p and troughs t. As shown, the ribbed structure 710 has a wave shape that results from the addition of multiple sinusoidal waves with varying wavelengths. In other words, the ribbed structure 710 has an irregular or complex wave shape. The ribbed structure 710 can have a set of ribs that each have a maximum (e.g., characterized by a peak p) and a minimum (e.g., characterized by a trough t) and one or more local maxima and minima between the maximum and the minimum. In some embodiments, shape irregularities that result from the addition of multiple sinusoidal waves can improve the structural stability of the ribbed structure 710 by more evenly dispersing strain throughout various points of the ribbed structure 710. As shown, the ribbed structure 710 has a y-value (e.g., height) that varies along the x-axis (e.g., a lateral dimension) and a y-value that remains substantially constant along the z-axis. In other words, the ribbed structure 710 is shown as being substantially homogeneous along the z-axis. In some embodiments, the ribbed structure 710 can exhibit heterogeneity along the z-axis. For example, when moving along the z-axis with a constant x-value, the y-value can exhibit local maxima, local minima, absolute maxima and/or absolute minima. In some embodiments, the y-value can exhibit similar behavior when moving along the z-axis with a constant x-value to the behavior exhibited by the y-value when moving along the x-axis with a constant z-value. In some embodiments, the y-value can exhibit different behavior when moving along the z-axis with a constant x-value when compared to the behavior exhibited by the y-value when moving along the x-axis with a constant z-value.

In some embodiments, the ribbed structure 710 can have the same or substantially similar physical and mechanical properties to other ribbed structures described herein (e.g., the ribbed structure 110 as described above with reference to FIG. 1).

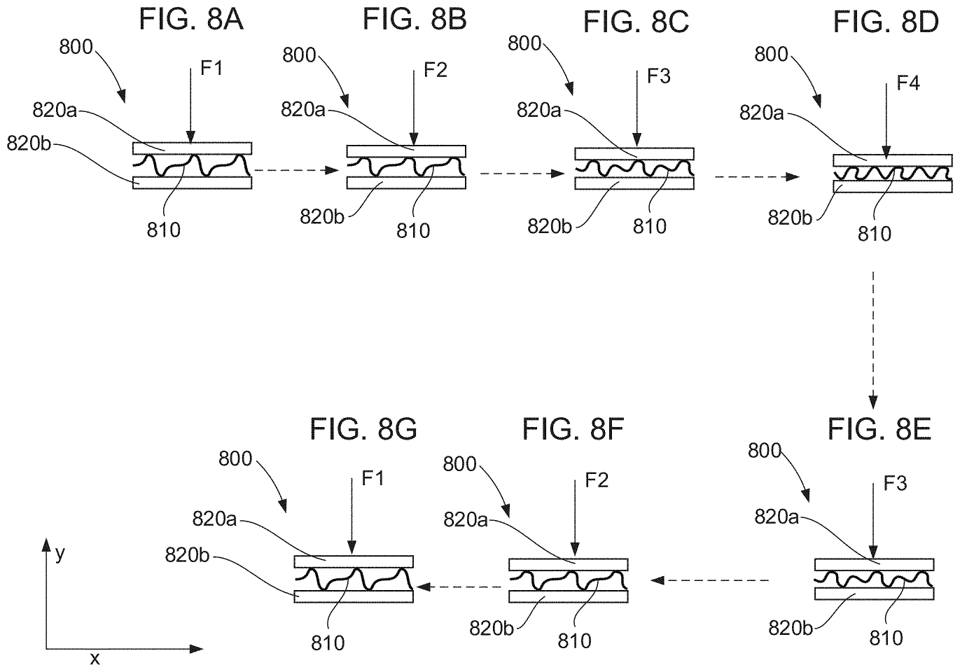

FIGS. 8A-8G show an apparatus 800 with a ribbed structure 810 subject to elastic deformation, according to an embodiment. The apparatus 800 includes a first layer 820a (e.g., a top rigid surface) and a second layer 820b (e.g., a bottom rigid surface). As shown, the apparatus 800 is subjected to applied forces F1, F2, F3, and F4, each applied downward along the y-axis to displace the first layer 820a while the second layer 820b remains fixed, wherein F2>F1, F3>F2, and F4>F3. FIGS. 8A, 8B, 8C, and 8D show the progression of material deformation of the ribbed structure 810 in response to the application of a force that increases in magnitude from a value of F1 to F4. FIGS. 8D, 8E, 8F, and 8G, show elastic recovery of the ribbed structure 810 when the force applied decreases from F4 to F1. As shown, the ribbed structure 810 exhibits several elastic deformations in the form of structural bends of the ribbed structure 810 in response to the applied forces F1, F2, F3, and F4. Stated differently, the ribbed structure 810 can exhibit a sequence of deformations, which can be reversible.

In some embodiments, the ribbed structure 810 can deform elastically or substantially elastically in response to a force (e.g., a shock) incident the apparatus 800 of at least about 1,000 N, at least about 2,000 N, at least about 3,000 N, at least about 4,000 N, at least about 5,000 N, at least about 6,000 N, at least about 7,000 N, at least about 8,000 N, at least about 9,000 N, at least about 10,000 N, at least about 15,000 N, at least about 20,000 N, at least about 25,000 N, at least about 30,000 N, or at least about 35,000 N, inclusive of all values and ranges therebetween.

The ribbed structure 810 can have a cross-section that is the same as or substantially similar to the cross-section of ribbed structure 710 depicted in FIG. 7C. The wave shape of the ribbed structure 810 can contribute to the elastic behavior of the ribbed structure 810 under loading. In some embodiments, the frequency, amplitude, wavelength, peak-to-peak period, overall height, material thickness, and/or material composition of the ribbed structure 810 can contribute to its elastic behavior under loading. As depicted in FIGS. 8A-8D, the ribbed structure 810 can have a beam or truss-like deformation, with a sequenced pattern of deformation. In some embodiments, a cross-section of the ribbed structure 810 can re-organize the beam- or truss-like network during the deformation process, including stages that may involve beam bending, shear, buckling, and/or other distinct stress combinations. In some embodiments, the exploitation of such beam-like deformation can enable mechanical and dynamic property control of the ribbed structure 810 more effectively than mechanical and dynamic property control of the bulk material from which the ribbed structure 810 is derived. In some embodiments, these properties can include mechanical stiffness and/or modulus, Poisson's ratio, and damping behavior.

In some embodiments, the apparatus 800, the ribbed structure 810, the first layer 820a, and the second layer 820b can have the same or substantially similar physical and mechanical properties to the apparatus 100, ribbed structure 110, the first layer 120a, and the second layer 120b as described above with reference to FIG. 1.

FIGS. 9A-9D show an apparatus 900 with a ribbed structure 910 formed into a cylindrical shape, according to an embodiment. The ribbed structure 910 is shown in an auxiliary view in FIG. 9A and in a side view or cross-sectional view in FIG. 9B. In FIG. 9C, the ribbed structure 910 has been formed into a ring or cylindrical shape. In FIG. 9D, a first layer 920a and a second layer 920b have been added to the ribbed structure 910 to form the apparatus 900. The apparatus 900 has a cylindrical shape that can be incorporated into any environment where absorption of shock and/or vibration are desired. Examples of environments, wherein the incorporation of the apparatus 900 with a cylindrical shape can be advantageous, are described in the '501 patent. In some embodiments, the apparatus 900 can be incorporated into cables, wires, columns, etc., where a cylindrical structure can be useful for shock damping.

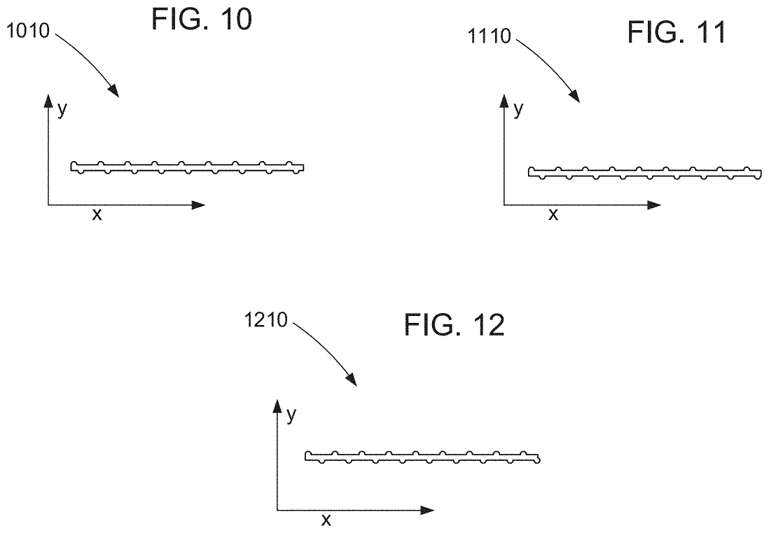

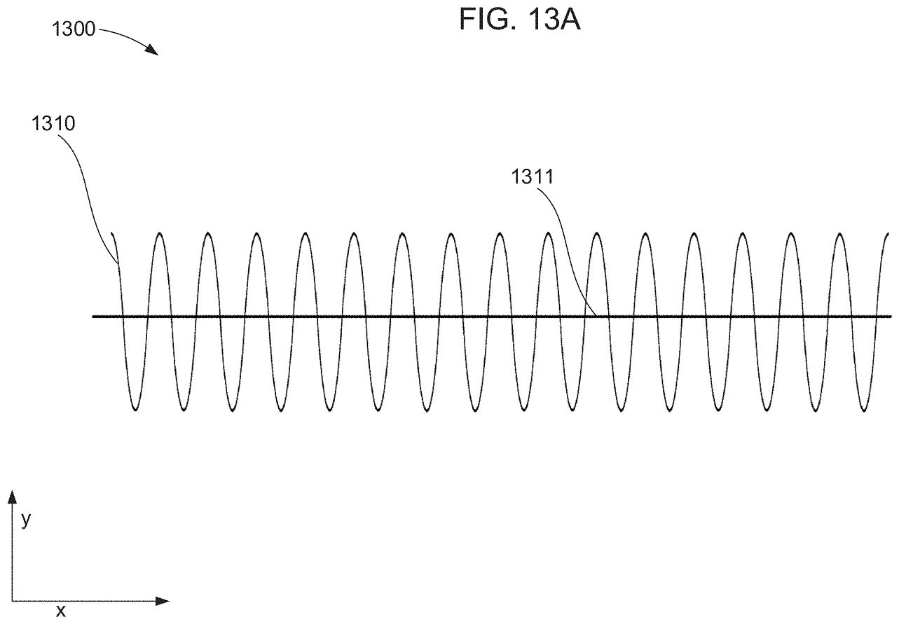

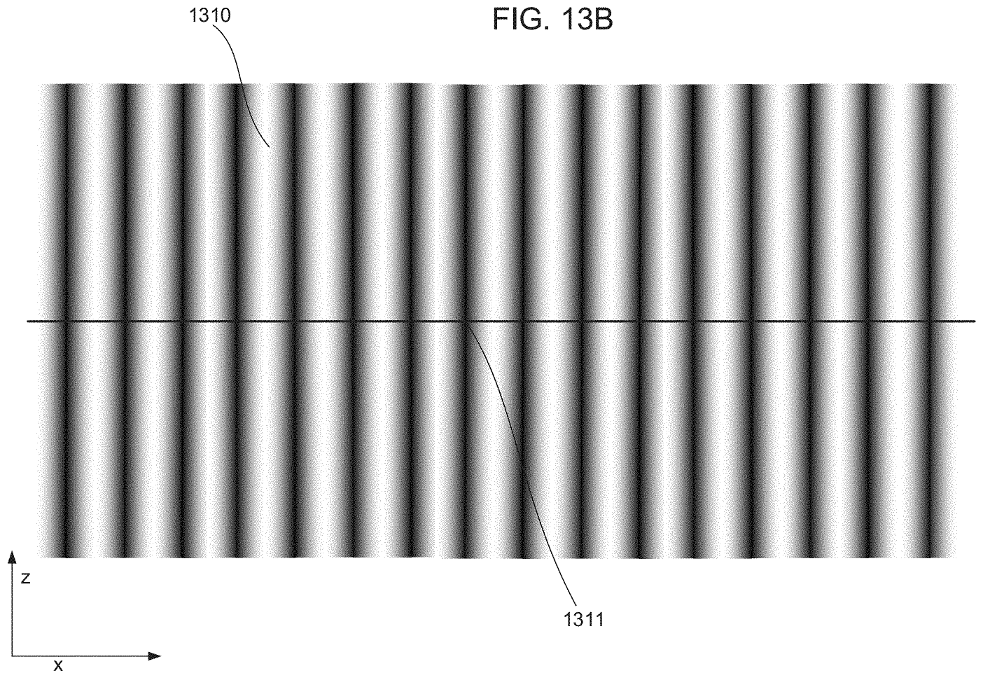

The ribbed structure 910 can include projections or ribs on both side of a laterally extending surface or layer. In some embodiments, the ribs can be independently added to a cross-section design (e.g., of a sheet). As shown, the ribs are in-phase. In other words, each rib is shown with an additional rib on the opposite side of the ribbed structure 910 with substantially no shift in the x-direction. In some embodiments, the ribs can be out of phase, as shown in FIG. 10, FIG. 11, and FIG. 12. For example, a ribbed structure can exhibit phase change in its rib periodicity. FIG. 10 includes a ribbed structure 1010 with ribs slightly out of phase, such that each rib on the top of the ribbed structure 1010 has a right edge that is approximately in-line with a left edge of each rib on the bottom of the ribbed structure 1010. FIG. 11 includes a ribbed structure 1110 with ribs significantly out of phase, such that each rib on the top of the ribbed structure 1110 has substantially no overlap with each rib on the bottom of the ribbed structure 1110. FIG. 12 includes a ribbed structure 1210 with ribs significantly out of phase, such that each rib on the top of the ribbed structure 1210 is approximately equidistant between two ribs on the bottom of the ribbed structure 1210.

In some embodiments, the apparatus 900, the ribbed structure 910, the ribbed structure 1010, the ribbed structure 1110, the ribbed structure 1210, the first layer 920a, and the second layer 920b can have the same or substantially similar physical and mechanical properties to the apparatus 100, ribbed structure 110, the first layer 120a, and the second layer 120b as described above with reference to FIG. 1.

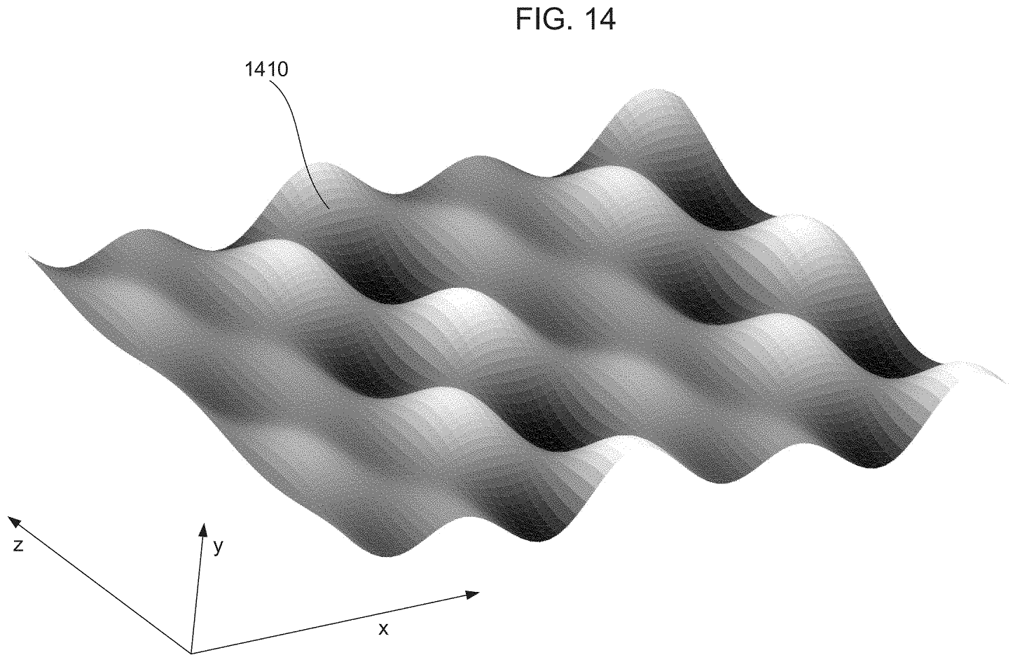

FIGS. 13A-13B show a ribbed structure 1310, according to an embodiment. FIG. 13A shows side view or cross-sectional view of the ribbed structure 1310 and FIG. 13B shows an overhead view of the ribbed structure 1310. As shown, the ribbed structure 1310 includes one or more stiffener(s) 1311 disposed therein. As shown, stiffener(s) 1311 can be component(s) that run along the width (i.e., x-direction) of the ribbed structure 1310. Stiffener(s) 1311 can be oriented orthogonally to the ribs of the ribbed structure 1310. Stiffener(s) 1311 can create greater rigidity of motion in a lateral plane of the ribbed structure 1310, which resists flattening out when a load is applied between top and bottom surfaces of the ribbed structure 1310.

Stiffener(s) 1311 can be implemented as a single structure that extends substantially the entire width of the ribbed structure 1310 along the x-axis. In some embodiments, stiffener(s) 1311 can include multiple stiffeners 1311 extending substantially the entire width of the ribbed structure 1310 along the x-axis. In some embodiments, multiple stiffeners 1311 can be disposed along the width of the ribbed structure 1310 in a discontinuous pattern. In other words, a first stiffener can attach to the sides or ends (e.g., along the x-axis) of a first rib of the ribbed structure 1310, a second stiffener can attach to the sides or ends of a second rib of the ribbed structure 1310, a third stiffener can attach to the sides or ends of a third rib of the ribbed structure 1310, and so on. In some embodiments, a single stiffener (e.g., a rod or other elongate structure) can be disposed through 1, 2, 3, 4, 5, 6, 7, 8, 9, 10, 11, 12, 13, 14, 15, 16, 17, 18, 19, 20, or more than about 20 ribs of the ribbed structure 1310. In some embodiments, the stiffener 1311 can be formed of the same material as the ribs of the ribbed structure 1310. In some embodiments, the stiffener 1311 can be composed of a polymer, a metal, a rubber material, an elastic material, or any combination thereof.

In some embodiments, the ribbed structure 1310 can have the same or substantially similar physical and mechanical properties to ribbed structure 110 as described above with reference to FIG. 1.

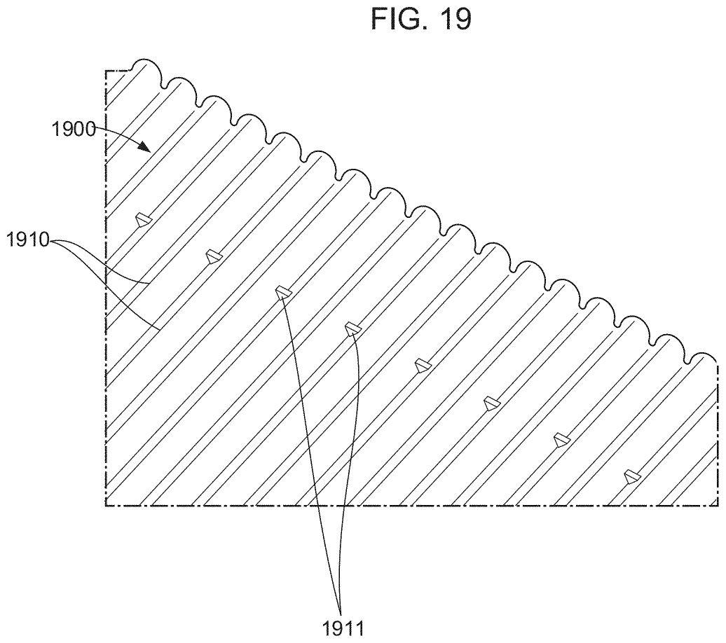

In some embodiments, multiple stiffeners can be disposed in a ribbed structure in a discontinuous pattern. For example, as depicted in FIG. 19, a first stiffener 1911 can be disposed in a first rib of a ribbed structure 1910, and a second stiffener 1911 can be disposed in a second, non-adjacent rib of the ribbed structure 1910, with no stiffeners disposed in a rib between the first and second ribs of the ribbed structure 1910.

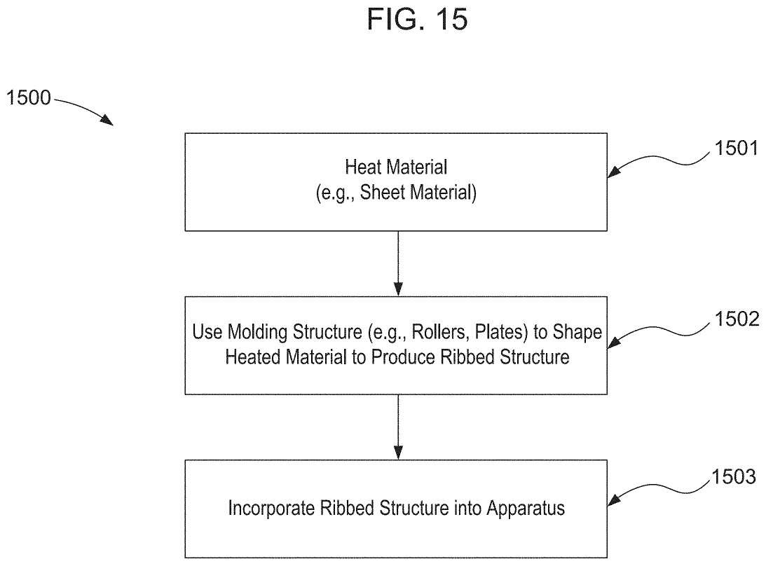

FIG. 14 shows a ribbed structure 1410, according to an embodiment. The ribbed structure 1410 has rib patterns that occur in two dimensions. In other words, the ribbed structure 1410 has heterogeneity along the x-y plane as well as along the y-z plane. In some embodiments, the ribbed structure 1410 can have local maxima and minima in the y-direction as well as absolute maxima and minima in the y-direction. In other words, the y-value of the ribbed structure 1410 can change heterogeneously along both the x-axis and the z-axis. In some embodiments, the ribbed structure 1410 can be formed via a thermoforming process and/or a stamping process, which can aid in changing static and dynamic performance of the ribbed structure 1410.

In some embodiments, the ribbed structure 1410 can have the same or substantially similar physical and mechanical properties to ribbed structure 110 as described above with reference to FIG. 1.

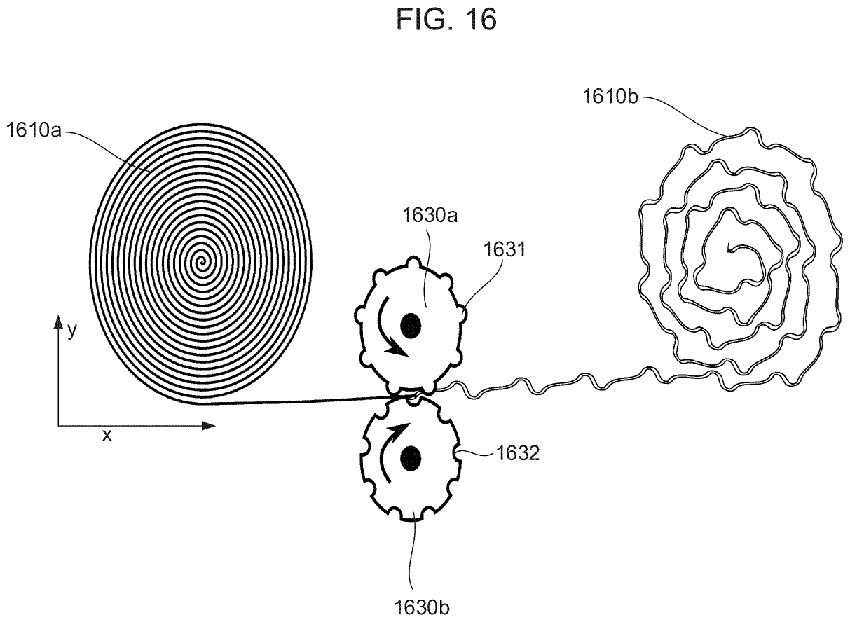

FIG. 15 shows a method 1500 of producing an apparatus including a ribbed structure, according to an embodiment. The method 1500 includes heating a material (e.g., a sheet material) at step 1501, using a molding structure (e.g., rollers, plates) to shape the heated material to produce a ribbed structure at step 1502, and incorporating the ribbed structure into an apparatus at step 1503.

In some embodiments, the material being heated in step 1501 can include any of the materials that comprise the ribbed structure 110, as described above with reference to FIG. 1. In some embodiments, step 1501 can include heating the material to a temperature sufficient to increase the malleability and/or formability of the material. In some embodiments, step 1501 can include heating the material to a temperature sufficient to melt the material. In some embodiments, step 1501 can include heating the material to a temperature less than the melting point of the material.

In some embodiments, step 1501 can include heating the material to a temperature of at least about 50° C., at least about 100° C., at least about 150° C., at least about 200° C., at least about 250° C., at least about 300° C., at least about 350° C., at least about 400° C., or at least about 450° C., In some embodiments, step 1501 can include heating the material to a temperature of no more than about 500° C., no more than about 450° C., no more than about 400° C., no more than about 350° C., no more than about 300° C., no more than about 250° C., no more than about 200° C., no more than about 150° C., no more than 100° C., or no more than about 50° C. Combinations of the above-referenced ranges are also possible (e.g., at least about 50° C. to no more than about 500° C., or at least about 100° C. to no more than about 400° C.), inclusive of all values and ranges therebetween. In some embodiments, step 1501 can include heating the material to a temperature of about 50° C., about 100° C., about 150° C., about 200° C., about 250° C., about 300° C., about 350° C., about 400° C., about 450° C., or about 500° C.

At step 1502, the heated material is formed into a ribbed structure. In some embodiments, the material can be softened and malleable from the applied heat, and can be formed into a desired shape to form the ribbed structure. In some embodiments, the heated material can be formed into the desired shape via one or more rollers, a mold, or any other suitable forming process. In some embodiments, step 1502 can include vacuum forming. In some embodiments, step 1502 can include pressure forming. In some embodiments, step 1502 can include feeding a fully melted (i.e., liquefied) material into a mold with the desired form factor. The melted or liquid material can then be cooled to reform into a solid. The solid can then be removed from the mold as the ribbed structure.

Step 1503 includes incorporating the ribbed structure into an apparatus. In some embodiments, this can include coupling the ribbed structure to a first layer and a second layer. In some embodiments, the ribbed structure, the first layer, and the second layer and the couplings therebetween can have the same or substantially similar properties to the ribbed structure 110, the first layer 120a, the second layer 120b, and the couplings therebetween, as described above with reference to FIG. 1.

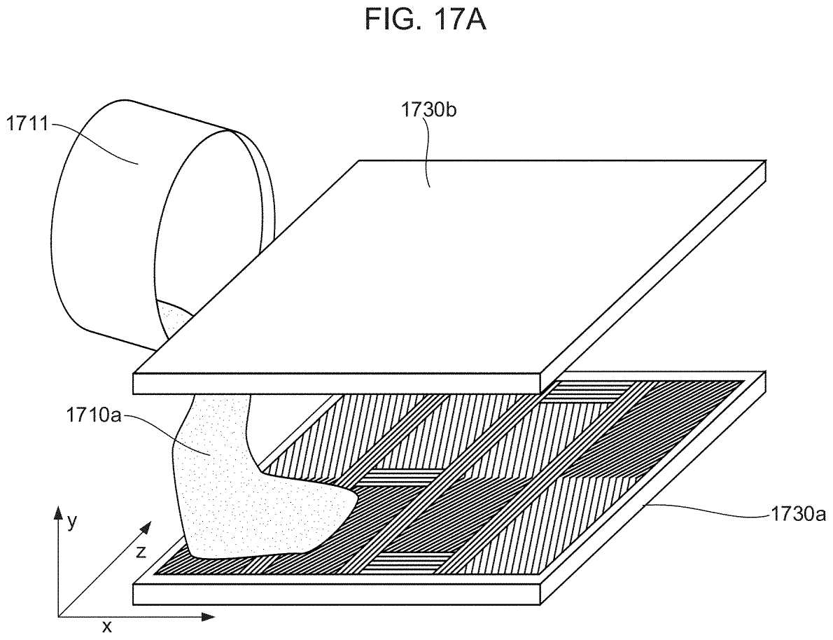

FIG. 16 shows an example device and method for producing a ribbed structure 1610b, according to an embodiment. The example device includes a top roller 1630a and a bottom roller 1630b (collectively referred to as rollers 1630) through which a sheet material 1610a is fed to form the ribbed structure 1610b.

In some embodiments, the sheet material 1610a and the ribbed structure 1610b can include any of the materials that comprise the ribbed structure 110, as described above with reference to FIG. 1. In some embodiments, the sheet material 1610a can be a heated material. In some embodiments, the rollers 1630 can be configured to heat the sheet material 1610a as the sheet material is fed through the rollers 1630. In other embodiments, the sheet material 1610a can be heated prior to being fed through the rollers 1630, e.g., using a heating device (not depicted). In some embodiments, the sheet material 1610a can be heated to any of the temperatures or temperature ranges described above in step 1501 with reference to FIG. 15. As shown, the sheet material 1610a is wound onto a spool. In some embodiments, the sheet material 1610a can be delivered to the rollers 1630 from a conveyor system, or via any other suitable delivery method.

The rollers 1630 form the sheet material 1610a into a desired shape. For example, the top roller 1630a includes protuberances 1631, while the bottom roller 1630b includes cavities 1632. In some embodiments, both the top roller 1630a and the bottom roller 1630b can include protuberances 1631. In some embodiments, both the top roller 1630a and the bottom roller 1630b can include cavities 1632. As shown, the rollers 1630 have a round shape. In some embodiments, the rollers 1630 can have a triangular shape, a square shape, a polygonal shape, an elliptical shape, or any other shape suitable for forming the rib blank 1610a into the ribbed structure 1610b. As shown, the method includes two rollers 1630. In some embodiments, the example device can include the use of 1, 3, 4, 5, 6, 7, 8, 9, 10, or more rollers 1630. For example, one or more rollers 1630 can be exchanged for other rollers before, during, or after forming a ribbed structure. The ribbed structure 1610b can be cooled, e.g., using a cooling device (not depicted) situated downstream of the rollers 1630, or via room temperature, such that it hardens enough to be mechanically stable. In some embodiments, the ribbed structure 1610b can be the same or substantially similar to the ribbed structure 110, as described above with reference to FIG. 1.

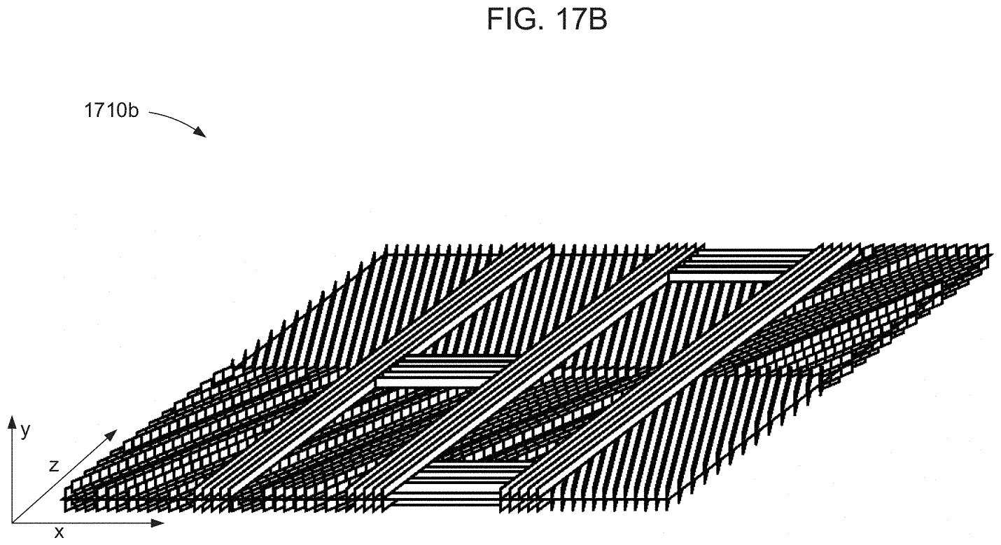

FIGS. 17A and 17B show an example device and method of producing a ribbed structure, according to an embodiment. The example includes feeding a material 1710a into a bottom plate 1730a and pressing a top plate 1730b onto the bottom plate 1730a to form a ribbed structure 1710b. As shown, the material 1710a is liquefied. In some embodiments, the material 1710a can be a malleable or formable solid, as described above with reference to FIG. 15. As shown, the material 1710a is poured into the bottom plate 1730a from a liquid container 1711. In some embodiments, the material 1710a can be delivered to the bottom plate 1730a via a series of pumps and pipes, an injection system, or any other suitable delivery mechanism. In some embodiments, the material 1710a can be heated to any of the temperatures or temperature ranges described above in step 1501 with reference to FIG. 15, e.g., via a heating device integrated into the liquid container 1711 or a separate heating device. In some embodiments, the material 1710a and the ribbed structure 1710b can be composed of an elastomeric material.

As shown, the bottom plate 1730a has a positive pattern, while the top plate 1730b has a negative pattern. In some embodiments, the bottom plate 1730a can have a negative pattern while the top plate 1730b has a positive pattern. As shown, the bottom plate 1730a and the top plate 1730b include patterns with a non-constant cross section along the x-axis and along the z-axis. In other words, the bottom plate 1730a and the top plate 1730b form the ribbed structure 1710b into a pattern that changes when moving along the x-axis or the z-axis. In some embodiments, a non-constant cross section along the x-axis and/or the z-axis of the ribbed structure 1710b can be employed to mitigate shear and compression loads that are incident from the front side, the back side, the right side, the left side, or at off-angles. In some embodiments, a non-constant cross section along the x-axis or the z-axis of the ribbed structure 1710b can be employed to realize aesthetic patterns in the ribbed structure 1710b.

In some embodiments, the bottom plate 1730a and the top plate 1730b can have a pattern that has a constant or substantially constant cross section along the x-axis, such that the ribbed structure 1710b has a pattern that does not significantly change along the x-axis. In some embodiments, the bottom plate 1730a and the top plate 1730b can have a pattern that constant or substantially constant cross section along the z-axis, such that the ribbed structure 1710b has a pattern that does not significantly change along the z-axis. In some embodiments, the ribbed structure 1710b can be formed via compression molding. The ribbed structure 1710b can be cooled, such that it hardens enough to be mechanically stable. In some embodiments, the ribbed structure 1710b can be the same or substantially similar to the ribbed structure 110, as described above with reference to FIG. 1.

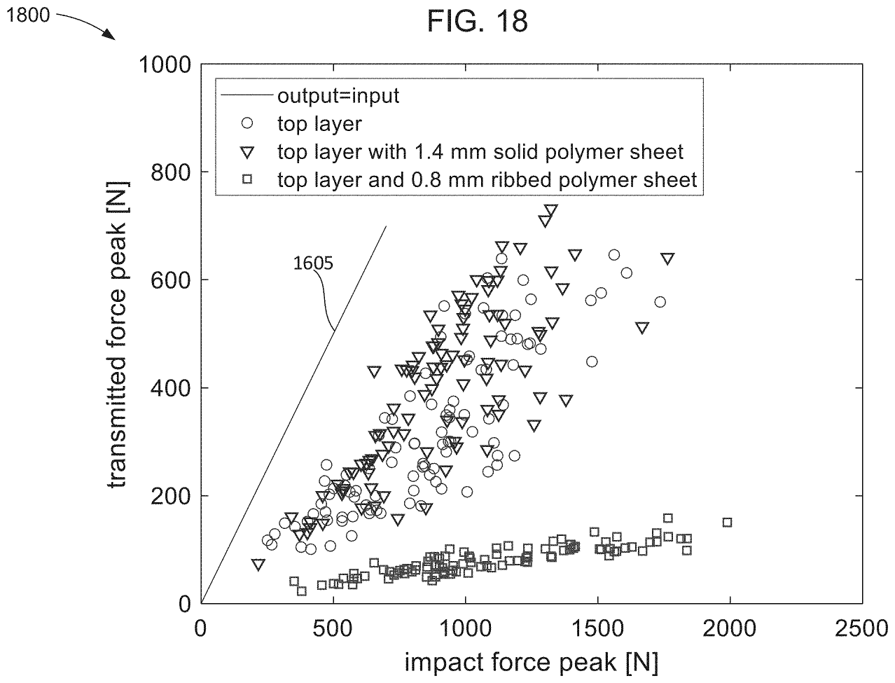

FIG. 18 shows a plot 1800 of peak transmitted force vs. peak impact force for apparatuses with and without ribbed structures. The plot 1800 shows results of tests conducted measuring peak impact force applied at a point onto a top layer and with concurrent data of the peak transmitted force obtained below the top layer, with and without an additional layer, as further described below. The solid line 1805 indicates nominal conditions of output force (transmitted force) identical to input force (impact force), indicating no energy dissipation through the layers. The circle data points correspond to the use of a top layer of material, without any additional layer of material, and indicates that the top layer reduces some force transmission from the impact condition level. By adding a 1.4 mm solid polymer sheet below the top layer, there is no statistical reduction of transmitted force, as indicated by the triangle data points in plot 1800. With the addition of a ribbed polymer material fabricated from 0.8 mm thick polymer sheet, substantial transmitted force reduction is achieved, as indicated by the square data points in plot 1800. More specifically, over 5 times less force is transmitted when the ribbed polymer material is used when compared to the force being transmitted through the top layer with or without the solid polymer sheet.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisionals, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of” or, when used in the embodiments, “consisting of” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. An apparatus, comprising:
a ribbed structure extending along a lateral plane and including a set of ribs,
the ribbed structure changing in height along a dimension of the lateral plane,
the ribbed structure configured to elastically deform according to a sequence of stages in response to an increasing force being applied to the ribbed structure, each stage from the sequence of stages exhibiting different stress behavior.

2. The apparatus of claim 1, wherein the ribbed structure has a plurality of sections including:
a first section including a first subset of ribs having a first set of characteristics; and
a second section including a second subset of ribs having a second set of characteristics different from the first set of characteristics,
the first section configured to deform differently from the second section in response to the increasing force being applied to the ribbed structure.

3. The apparatus of claim 2, wherein the first subset of ribs has periodicity exhibiting a first wavelength, and the second subset of ribs has periodicity exhibiting a second wavelength different from the first wavelength.

4. The apparatus of claim 2, wherein the first subset of ribs has first amplitude and the second subset of ribs has a second amplitude different from the first amplitude.

5. The apparatus of claim 2, wherein the first subset of ribs exhibit a first waveform and the second subset of ribs exhibit a second waveform different from the first waveform.

6. The apparatus of claim 1, wherein each rib from the set of ribs includes a peak, a through, and one or more local maxima and local minima disposed between the peak and the through.

7. The apparatus of claim 1, wherein the set of ribs exhibit a complex waveform formed from a plurality of sine waveforms each associated with a different wavelength.

8. The apparatus of claim 1, wherein the ribbed structure has a thickness that changes along a lateral or a longitudinal axis of the ribbed structure.

9. The apparatus of claim 8, wherein the thickness of the ribbed structure changes gradually along the lateral or the longitudinal axis.

10. The apparatus of claim 1, wherein the ribbed structure is a first ribbed structure and the set of ribs is a first set of ribs, the first set of ribs defining a first plurality of peaks and troughs, the apparatus further comprising:
a second ribbed structure including a second set of ribs, the second set of ribs defining a second plurality of peaks and troughs,
the second ribbed structure coupled to the first ribbed structure where each peak of the second plurality of peaks and troughs is coupled to a different trough of the first plurality of peaks and troughs.

11. The apparatus of claim 1, further comprising:
a first layer disposed on a first side of the ribbed structure; and
a second layer disposed on a second side of the ribbed structure.

12. The apparatus of claim 11, wherein a combined height of the first and second layers and the ribbed structure is between about 1 mm and about 5 cm.

13. The apparatus of claim 11, wherein the first and second layers each have a cylindrical shape, and the ribbed structure is shaped as a ring that is disposed between the first and second layers.

14. The apparatus of claim 1, wherein the dimension is a first dimension, the ribbed structure further changing in height along a second dimension of the lateral plane.

15. The apparatus of claim 1, wherein the set of ribs defines a plurality of peaks, the apparatus further comprising a set of stiffeners disposed in a set of peaks from the plurality of peaks, the set of stiffeners configured to increase a rigidity of the ribbed structure in the lateral plane.

16. The apparatus of claim 1, wherein the ribbed structure in deforming according to the sequence of stages is configured to attenuate forces associated with a shock applied to the ribbed structure.

17. An apparatus, comprising:
a ribbed structure including a set of ribs, the ribbed structure configured to deform elastically under shock, the ribbed structure including:
a first section including a first subset of ribs having a first set of characteristics; and
a second section including a second subset of ribs having a second set of characteristics different from the first set of characteristics, such that the first section and the second section have different mechanical properties.

18. The apparatus of claim 17, wherein the first subset of ribs has a pattern that changes along a first dimension of the ribbed structure, and the second subset of ribs has a pattern that changes along a second dimension of the ribbed structure that is different from the first dimension.

19. The apparatus of claim 17, wherein the first subset of ribs exhibits a first waveform and the second subset of ribs exhibits a second waveform, the second waveform being different from the first waveform.

20. The apparatus of claim 17, wherein the first subset of ribs has a waveform with a first periodicity and the second subset of ribs has a waveform with a second periodicity, the second periodicity different from the first periodicity.

21. The apparatus of claim 17, wherein the first subset of ribs has a waveform with a first amplitude and the second subset of ribs has a waveform with a second amplitude, the second amplitude different from the first amplitude.

22. A method, comprising:
heating a material;
shaping the material into a ribbed structure including a set of ribs; and
coupling the ribbed structure to one or more rigid layers such that the ribbed structure is configured to attenuate forces associated with a shock applied to an exterior surface of the one or more rigid surfaces.

23. The method of claim 22, wherein the shaping the material includes at least one of:
embossing the material, thermoforming the material, stamping the material, rolling the material, compression molding the material, vacuum molding the material, or casting the material.

24. The method of claim 22, wherein the material is a sheet material, and the shaping the material includes feeding the sheet material through two rollers that collectively define a periodic waveform associated with the set of ribs of the ribbed structure.

25. The method of claim 22, wherein the material is a formable solid, and the shaping the material includes placing the formable solid in liquid form between two plates that collectively define the ribbed structure.
